(19) United States
(12) Patent Application Publication
(10) Pub. No.: US 2010/0205020 A1
(43) Pub. Date: Aug. 12, 2010

(54) SYSTEM AND METHOD FOR ESTABLISHING, MANAGING, AND CONTROLLING THE TIME, COST, AND QUALITY OF INFORMATION RETRIEVAL AND PRODUCTION IN ELECTRONIC DISCOVERY

(76) Inventor: Ralph C. Losey, Winter Park, FL (US)

Correspondence Address: Ralph C. Losey, Esq., 1661 Woodland Ave., Winter Park, FL, 32789, US

(21) Appl. No.: 12/367,821

(22) Filed: Feb. 9, 2009

(51) Int. Cl. G06Q 10/00; G06F 17/30

(52) U.S. Cl. 705/7

(57) ABSTRACT

A cost and quality controlled system for transforming collections of computer files and other electronically stored information by iterative culling and sorting so that production of relevant information can be made within estimated time and costs ranges and precision and recall ratios.

### TECHNICAL FIELD

The present invention relates to electronic discovery (“e-discovery”) in the context of litigation and other situations where disclosure of electronically stored information is compelled or required by law or necessity, and more particularly, to a method for controlling the time, costs, and quality of production.

### BACKGROUND ART

Corporations and individuals are increasingly subject to legal demands for disclosure of computer files and other electronically stored information (“ESI”). The term ESI shall henceforth be used broadly to include all computer-generated files, but shall also include all other types of digital and electronically stored information, such as voice mails recordings and the like. The legal demands for disclosure arise in civil and criminal litigation, government investigations, regulatory compliance, mergers and acquisitions, and other situations where disclosure of ESI is required by law, necessity, or research. Effective Dec. 1, 2006, new and revised Federal Rules of Civil Procedure (“FRCP”) went into effect to address e-discovery issues. The new rules included Rule 34(a) FRCP, which was revised to state:
Scope. Any party may serve on any other party a request (1) to produce and permit the party making the request, or someone acting on the requestor's behalf, to inspect, copy, test, or sample any designated documents or electronically stored information—including writings, drawings, graphs, charts, photographs, sound recordings, images, and other data or data compilations stored in any medium—from which information can be obtained, translated, if necessary, by the respondent into reasonably usable form, or to inspect, copy, test, or sample any designated tangible things which constitute or contain matters within the scope of Rule 26(b) and which are in the possession, custody or control of the party upon whom the request is served; (emphasis added).

The retrieval of relevant ESI stored in large, disorganized collections of computer files has proven to be extremely difficult and expensive to accomplish. The task has continuously grown more difficult as businesses and governments move from paper records to ESI. Today most organizations store vast quantities of ESI, now commonly measured in terabytes of information, most all of which must be searched in response to legal obligation to make disclosure of information. See G. Paul, J. Baron, Information Inflation: Can The Legal System Adapt? 13 Rich J. L. & Tech 10 (2007). The search and retrieval of relevant ESI from these vast, disorganized stores of data frequently places a tremendous monetary, time, and interruption burden upon the persons and entities responding to these information disclosure demands (hereinafter “responding parties”).

### New Interdisciplinary Field of e-Discovery

The legal profession has necessarily turned to information technology engineers and information scientists for assistance to fulfill legal obligation to search and produce relevant ESI. Approximately fifteen years ago this led to the creation of a new field of study and practice that combines skills and knowledge of law, engineering, and information science. The field has grown substantially since the enactment of amended FRCP by Congress effective Dec. 1, 2006. This new interdisciplinary filed of law and information technology and science is now commonly known as “electronic discovery” or “e-discovery.”

FIG. 1 of the Drawings is an industry standard chart known as the Electronic Discovery Reference Model (“EDRM”) FIG. 1. It shows the nine-steps of e-discovery work in a flow-chart model moving from left to right.

The first step, Records Management—1, is concerned with information organization that precedes e-discovery work proper. The e-discovery process begins when a demand is made upon responding parties for production of ESI. The demand can come in many forms, but the most common is a formal discovery pleading served by one party in litigation upon another, which is known as a Request For Production (“RFP”) under Rule 34 FRCP. This demand triggers the second and third steps of the EDRM model: Identification—2, and Preservation—3. Here any storage areas of electronic information that might contain ESI that is responsive to the RFP are identified, and then most, but not necessarily all of that ESI is preserved for later possible collection. The next step, Collection—4, is the actual harvesting of the bulk ESI datasets that have been identified as possibly containing ESI relevant and responsive to the RFP. This is done by making copies of the ESI following forensic methods and chain of custody protocols.

The collected ESI is then typically stored in protected “write once, read many times,” a/k/a “WORM”, media, such as read-only CDs, DVDs, or portable hard drives, where it becomes available for further computer processing. Then the fifth, sixth and seventh steps in FIG. 1 take place: Processing—5, Review—6, and Analysis 7. In these steps the amount of ESI is reduced and made ready for the next step shown in FIG. 1, 8 Production, where the final culled down and approved ESI is actually provided to the requesting parties. Again, the production is typically made on WORM type media. The ninth step of FIG. 1, 9 Presentation, concerns the actual use of the ESI as evidence in any later legal proceedings, such as hearings and trial.

Responding parties must locate potentially responsive ESI, which is the second step of Identification, and then review the ESI by computerized and computer-assisted methods (the Processing, Review and Analysis steps) before it is produced. The 5 Processing, 6 Review and 7 Analysis steps are performed in order to try to: (1) exclude ESI that was identified, preserved and collected, but is in fact not relevant to the particular request; and, (2) exclude information that is relevant, but otherwise protected from disclosure by law, such as attorney-client privilege, work-product privilege, or other privileges. The responding parties may also exclude, partially redact, or otherwise limit disclosure of any confidential information, including trade secrets.

The failure to exclude or protect privileged or confidential information from a production, which is typically equivalent to a public disclosure absent the entry of special confidentiality orders by supervising courts, can result in a waiver of these legal protections, sometimes with devastating impact on the responding parties. This is a strong motivating factor for a thorough and complete review and analysis of ESI before production. Further, responding parties generally attempt to protect their privacy rights, and the rights of their employees, by limiting production and not making disclosure of ESI that is not required. This also drives the need of responding parties to perform a thorough and accurate review and analysis of ESI before production.

In sum, e-discovery requires responding parties to search and review large stores of ESI and cull information that is not responsive, as well as information that is responsive, but is protected from disclosure on a number of legal grounds.

It is estimated that sixty percent or more of e-discovery expenses are derived from attorney or other professional billings, typically on a time-expended basis, to perform the search, culling, and final review of potentially relevant ESI before production. The large costs associated with such reviews and with e-discovery in general cause many to believe that the resolution of disputes in our civil justice system is becoming too expensive for most companies and individuals. In late 2007 this prompted Supreme Court Justice Stephen Breyer to express concern that, with ordinary cases costing millions just in e-discovery work, “you're going to drive out of the litigation system a lot of people who ought to be there” so that “justice is determined by wealth, not by the merits of the case.” The Economist, The Big Data Dump (Aug. 28, 2008).

Responding parties today are incurring these extraordinarily high costs by following a generally accepted protocol of attempting to find and cull the responsive ESI from the total data stores identified, preserved and collected, by the employment of a variety of search-culling techniques. They include keyword searches, Boolean keyword searches, and a many other types of artificial intelligence or concept searches. G. Paul, J. Baron, Information Inflation: Can The Legal System Adapt? 13 Rich J. L. & Tech 10 (2007); The Sedona Conference Best Practices Commentary on the Use of Search and Information Retrieval Methods in E-Discovery, 8 Sedona Conf. J. 189 (2007). The data filtering process, typically identified in the EDRM (FIG. 1) as step five, Processing, also culls down ESI by other methods such as date range restrictions, custodian restrictions, ESI storage system exclusions, and deduplication processes.

### Search Technologies and Information Science

There are a number of search techniques employed today, however, the most prevalent technique currently utilized by responding parties is keyword search filtering with Boolean logic connectors. Under this technique, if a computer file contains a specified keyword, then it is separated from the large data store for further review prior to production. If a file does not contain a specified keyword, it is automatically excluded from further review and production. The keyword filtering technique, like all other data culling techniques, including manual review of every file, is not totally accurate. In fact, studies have consistently shown that the accuracy of all manual and computer assisted reviews in large datasets is significantly less than fifty percent. This means that any culling process will always produce “false-positives” (files that contain a designated keyword or other indicator, but are not in fact relevant to the request) and will always exclude “false-negatives” (files that did not contain a designated keyword or other indicator, but are in fact relevant to the request).

The goal of any search technique is the retrieval of as high a percentage as possible of “true-positives,” that is, ESI selected by the automated search process that later expert review, typically the subject matter expert, which in the context of litigation is at first the reviewing attorneys and then ultimately the presiding judge, determines what was in fact responsive to the request. Conversely, the goal is also to exclude “true-negatives,” that is, ESI excluded by the automated search process that later expert review determines was in fact non-responsive and thus properly excluded. These four basic categories of search retrieval and exclusion are shown in FIG. 2 of the Drawings.

The standard terminology in information science to explain this quadrant of retrieval results employs the terms “precision” and “recall.” Recall refers to the completeness of a search; precision to the accuracy.

To explain further, “recall” measures the amount of relevant information retrieved by a particular search, compared to the total amount of relevant information contained in the data set searched. In this case, it represents the number of computer files containing information responsive to the RFP that were retrieved, the True Positives, out of all of the total number of computer files containing relevant information (True Positives plus False Negatives). In e-discovery involving large collections of computer files the total number of files containing responsive information is typically never known because it is never reviewed (it is never reviewed in its entirety because of the enormous expense). Thus although the number of True Positives is typically determined in the final human review and evaluation before production, the total number of False Negatives is not, at least not for the entire set. The formula for “recall” is expressed as follows: the number of relevant documents retrieved divided by the total number of relevant documents in the collection.

$$Recall = \frac{Number of Responsive Documents Retrieved}{Total Number Responsive}$$

Thus using the language of the standard search quadrant shown in FIG. 2, “recall” represents True Positives divided by the sum of the False Negatives and True Positives. Thus for instance, if it were somehow known that a collection of 1,000,000 files contained 100,000 files that were responsive to an RFP, and a search produced 150,000 files or hits, but only 50,000 of them were responsive (True Positives), with the remaining 100,000 hits being unresponsive (False Positives), then the “recall” formula would be 50,000 divided by 100,000, and the recall rate would be 50%.

“Precision” pertains only to the dataset collected by the search retrieval. It measures the amount of relevant information retrieved by a particular search, compared to the irrelevant information retrieved. In this case, it represents the number of computer files containing information relevant to the RFP that were retrieved, the True Positives, out of all of the total computer files retrieved (True Positives plus False Positives). This number can be determined in e-discovery, and indeed is the purpose of the final review before production. The formula for “precision” can be expressed by the following: number of relevant documents retrieved divided by the total number of retrieved documents.

$$Precision = \frac{Number of Responsive Documents Retrieved}{Total Number Retrieved}$$

Using the language of the search quadrant shown in FIG. 2, “precision” represents the number of True Positives divided by the sum of the number of False Positives and True Positives. Thus in the example above where the search retrieved 150,000 hits, but only 50,000 of them were responsive (True Positives), then the “precision” formula would be 50,000 divided by 150,000, and the precision rate would be 33.33%. Thus quality of search in information science is measured by both increased precision and recall. In e-discovery the recall measurements are necessarily based on sample projections because a full review of all documents in the data set is impractical, and, a statistical random sample produces acceptable error and confidence levels. See: EDRM Search Guide, Appendix 2: Application of Sampling to E-Discovery Search result evaluation, Jan. 20, 2009, draft v. 1.14.

### Current Art in e-Discovery

The search and review process currently employed in the legal industry for e-discovery involves the design of an automated culling process, using Boolean keyword search, enhanced indexing, fuzzy search, concept search, and/or other automated and artificial intelligence search processes. The search and culling processes are then run on various data sets to produce a more limited set for final review prior to production to the requesting parties. The final review (step six in EDRM, FIG. 1) is typically performed by a combination of human and computer-assisted reviews of the ESI. In these final processes data analysis is performed (the EDRM seventh step); irrelevant ESI is excluded and privileged or confidential ESI is logged or otherwise segregated for special treatment. The relevant ESI may also be categorized by issue or ranked according to degree of relevance or other classifications. The design of the initial culling search is either done alone by the producing parties or in conjunction and negotiation with the requesting parties, where, for instance, the parties attempt to agree upon a set of keywords and other limiting parameters.

It is not the current practice of responding parties, or requesting parties, to integrate projected estimations of the cost of a proposed search and review processes as part of the design of the automated culling process. Occasionally, some general costs of production are estimated, but when this is done, it is a very broad range of estimates at the beginning of a project. Under current practice, any price estimation performed is not integrated into the culling or search design process, is not iterative, and is not tied to quality control. Precise estimations and projections of cost and relevance quality (precision and recall) are thought to be impossible because of the generally unknown nature of the ESI examined in each case, the chaotic nature of the ESI storage, the inherently subjective nature of the relevancy determination, and the significantly varying characteristics of different types of ESI included in data collections, even from the same responding party.

### SUMMARY OF INVENTION

System and methods, according to aspects of the invention, are directed to economical, quality controlled search for ESI, including, without limitation, responses to requests for production (“RFP”) in litigation. Quality control refers to the effectiveness of the relevancy culling in terms of precision and recall. This can be accomplished through the transformation of collections of files and other ESI stored on computers and other electronic devices; computer files and ESI such as email, documents, spreadsheets, presentations, graphics, databases, and other similar machine and user-created data. The process pertains to large collections of ESI, typically over 10,000 computer files or more, and sometimes in large businesses and governments, involving billions or more computer files. There is no maximum size limit for the application of the invention, but a practical minimum of approximately 5,000 computer files.

The invention can work with computer file collections that are known to contain some files with information relevant to an information request, such as an RFP, and some files with no relevant information, and no precise knowledge as to which files are which, nor the specific content.

The invention transforms the ESI computer file collections by resorting and placing them into different groupings so as to cull the files projected to contain no relevant ESI, and then under one application to further sort files considered likely to contain relevant ESI into sub-groupings of files likely to contain certain types of relevant ESI, such as privileged or confidential ESI. This can be done by using various computer-culling and sorting processes, including search culling and search sorting, coupled with statistical quality control techniques, including acceptance-sampling. The acceptance sampling can be performed by computer-assisted human review of files selected by both random sampling and judgmental sampling.

The transformation by search culling and assortment of computer file collections allows parties searching for information to more quickly, efficiently, and accurately determine which files are responsive and should, for instance, be produced to satisfy legal or other obligations, and which should be withheld, and which should be withheld and logged or redacted. The process can be integrated with methods of cost estimation so that final review times and total production costs can be accurately projected and controlled. The method of cost estimation invented is carried out on computers and may use standard spreadsheet software and search software. The invented method is independent of the types of computers, spreadsheet, and search software employed.

The entire process invented is embodied on computers, is solely concerned with the manipulation of sets of computer data, cannot be performed manually, and requires one or more computers to be performed. Computers hold the collections of files that the invention transforms and computers carry out all of the search and culling processes.

The present claimed invention may utilize any type of computerized search algorithm to sort and cull ESI, including the Boolean keyword search algorithms most commonly in use today, but is not limited to any one type of search-culling method. More advanced artificial intelligence search algorithms, which are generally characterized as “concept” type searches, can also be used. These newly developing search-culling methods use taxonomies and ontologies assembled by linguists, and other machine learning and text mining tools that employ mathematical probabilities to identify ESI which is likely to contain relevant information. The new methods include, without limitation, Latent Semantic Indexing, Text Clustering and Bayesian classification systems. See: The Sedona Conference Best Practices Commentary on the Use of Search and Information Retrieval Methods in E-Discovery, Id.; EDRM Search Guide; Jan. 20, 2009, draft v. 1.14. The particular search technology used is not essential to the invented methodology.

The present claimed invention can be used in any situation where there is a need to find particular ESI, and not just RFPs or document subpoenas in civil litigation, which is the use demonstrated here. It may also be used in the context of: alternative dispute resolution proceedings, or any other legal or quasi-legal proceedings for the resolution of civil disputes; a required or voluntary disclosure of computer files in criminal investigations or prosecutions; a required or voluntary disclosure of computer files in government investigations, including securities, environmental, and other regulatory compliance; due diligence investigations for business transactions, mergers, and acquisitions; an internal investigation, risk management, or research project of any kind; a freedom of information request or other government obligation to make disclosure; or, any other required or voluntary research or disclosure of computer files, including corporate security, corporate research, and other research and information analysis type issues.

Under a system using aspects of the invention, the process sets up and culminates in decisions made by the attorney or other professional reviewers concerning judgments such as whether the computer files selected by the processes are in fact relevant and responsive, privileged, or confidential. This and various other mental processes occur after or outside of the claimed invention process. Of course, no claim is made to these decisions, nor any other mental processes, or to the ideas of cost estimation, search, or iterative quality control. The claimed invention is limited to the novel embodiment of these ideas in the invented systems and methodologies.

Under a system using aspects of the invention, a means can be provided for responding parties to maintain the costs of production of ESI within legal limits. The cost and quality of e-discovery productions can be managed by the inclusion of cost projections, statistical quality control, and acceptance sampling procedures into evolving, iterative, automated search and culling processes. In this iterative process the cost, precision, and projected recall of the search may be constantly monitored and improved.

Under a system using aspects of the invention, the responding parties do not complete design of an automated culling process, nor implement such a process, nor agree with the requesting parties on the parameters of such a process, without first engaging in a sampling and cost estimation process to test and refine possible culling and sorting formulas. The cost estimation process allows responding parties to make reliable estimates of the time and costs for final e-discovery attorney review and thereby the entire cost of production. The responding parties can be satisfied that the time and financial burdens likely to be created thereby in the form of review expenses are reasonable under the circumstances and governing law. The estimation and cost control methods can be integrated into quality control processes that test the precision and recall of the searches. The cost factors directly impact the refinement of the search and other culling criteria in an iterative feedback process. The other culling criteria in addition to search include such factors as date range and custodian limits.

The integration of cost projections, statistical quality control, and acceptance sampling into the design of the culling and sorting formulas significantly enhances the reasonability and impartiality of the process. This can be accomplished using aspects of the invention by measurements of the precision and projected recall of various tested culling and sorting formulas. This may be critical under a system using aspects of the invention, because requesting parties often challenge the ESI filtration processes used by responding parties and claim that they unreasonably, and thus in the context of compelled productions, unlawfully, limit the amount and quality of ESI produced. Such challenges may be rebutted by demonstration and proof of the reasonability of the culling and sorting processes that may be used in embodiments of the invention.

Under embodiments of the invention, cost estimation and statistical quality control and acceptance sampling are integrated together into evolving automated culling and segregation procedures. This creates substantial advantages to responding parties in all situations, but especially in the context of civil litigation. Although in civil litigation U.S. law generally imposes the burden of all costs of production upon the responding parties, the law also imposes reasonability limits on these costs. For that reason, all state and federal rules of procedure governing discovery in civil litigation limit the amount of time and money which responding parties must expend to respond to discovery requests. The amount is generally limited by the value and importance of the case. This is generally known as the “proportionality” principle and is found in all state and federal rules for civil litigation. For instance, in the Federal Rules of Civil Procedure it is contained in Rule 26(b)(2)(C).

For that reason, it is critical for responding parties to know the possible range of the cost of a discovery request as soon as possible and certainly before, and not after, the work is performed. If the estimates made by the responding parties using aspects of the invention show that the request is over-burdensome by virtue of proportionally excessive costs, responding parties can then object to the request and apply to the supervising court for protection. The court can then prohibit the request; require its revision so as to lessen the burden of the request; or shift all or part of the costs upon the requesting parties. By significantly improving cost intelligence before production commences, an implementation of the invention will improve and facilitate the protections available under the law to responding parties to limit the costs they may incur from a pending production request.

Alternative applications of systems and methods of the Invention can limit, or avoid altogether, the final human review of the computer files before production. This allows for very significant costs savings by responding parties by reduction of review times with protections from waiver of rights by inadvertent disclosure of confidential privileged provided by “Confidentiality,” “Clawback,” and/or “Quickpeek” agreements, and the terms and protection offered by newly enacted Rule 26(b)(5)(B), Federal Rules of Civil Procedure, and newly enacted Rule 502, Federal Rules of Evidence, and orders entered there-under.

These and other objects, features, and advantages of the present invention will become more apparent in light of the following detailed description of one best mode embodiment thereof as illustrated in the accompanying Drawings.

### BRIEF DESCRIPTION OF DRAWINGS

FIG. 1 is an Electronic Discovery Reference Model drawing showing industry standard nine-step flow chart of e-discovery work.

FIG. 2 is a drawing showing general fourfold data relevancy classification wherein the two quadrants on the top represent the retrieved data, both relevant (true positives) and irrelevant (false positives), and the two quadrants on the bottom represent the excluded data, both irrelevant (true negatives) and relevant (false negatives).

FIG. 3 is a drawing showing the total estimated volume of ESI potentially responsive to the RFP (the “Original Collection”) in the example demonstration considered in Step One of one embodiment of the Invention.

FIG. 4 is a sample computer generated output of an estimation spreadsheet for the costs of review of the Original Collection created at the end of Step One of one embodiment of the Invention.

FIG. 5 is a drawing showing the first reduction of the Original Collection, which creates the First Relevant Collection in the example considered in Step Two of the one embodiment of Invention, wherein the dark grey circle represents the Original Collection and the light grey box within the circle represents the First Relevant Collection.

FIG. 6 is a drawing showing the results of the 100-keyword combination search of a 20 GB sample set in the example considered in Step Three of the Invention. The grey box represents all of the ESI held by the 50 custodians selected, which is estimated to be 300 GBs. The blue circle represents a 20 GB sample consisting of 300,000 files on which the 100-keyword search was run. The red circle within the blue circle represents the 180,000 files occupying 10 GBs of space that contained one or more of the keyword combinations.

FIG. 7 is a sample computer generated output of an estimation spreadsheet for the costs of review of the First Relevant Collection created at the end of Step Three of one embodiment of the Invention.

FIG. 8—Drawing showing the second reduction of the Original Collection, which creates the Second Relevant Collection in the example considered in Step Four of the Invention. The square grey area in the drawing represents all of the files of the fifteen custodians. The irregularly shaped dark grey area is the Second Relevant Collection. It represents all of the files within the collection of the fifteen custodians that contain one of more hits from the 75-keyword combination search.

FIG. 9 is a sample computer generated output of an estimation spreadsheet for the costs of review of the Second Relevant Collection created at the end of Step Four of one embodiment of the Invention.

FIG. 10 is a drawing showing the review of both judgmental and random samples of the 445,500 files included by the 75-keyword combination and random samples of the 364,500 files excluded by the keywords considered in Step Five of one embodiment of the Invention. The irregularly shaped dark grey figure represents the Second Relevant Collection. The light grey area surrounding and outside of the Second Relevant Collection represents the Excluded Files. The red shapes numbered 1-10 represent samples of the top-10 keywords, some of which have overlapping files. The light blue splatters represent random samples of the Second Relevant Collection. The black splatters represent random samples of the Excluded Files.

FIG. 11 is a drawing showing the third reduction of the Original Collection, which creates the Third Relevant Collection in the example considered in Step Six of one embodiment of the Invention. The dark grey shape represents the Second Relevant Collection. The irregular red shape within the Second Relevant Collection represents the Third Relevant Collection. The irregular blue shape within the Third Relevant Collection represents files that e-discovery attorneys determined were responsive to the RFP and were produced. The white shape within the blue represents files that e-discovery attorneys determined were responsive to the RFP, but were privileged, and thus were logged and not produced.

FIG. 12 is a sample computer generated output of an estimation spreadsheet for the costs of review of the Third Relevant Collection created near the end of Step Six of one embodiment of the Invention.

FIG. 13 is a drawing showing last five steps in the Electronic Discovery Reference Model.

FIG. 14 is a Flow Chart of the overall system and method of one embodiment of the invention.

### DETAILED DESCRIPTION OF ONE OF MANY POSSIBLE EMBODIMENTS OF THE INVENTION

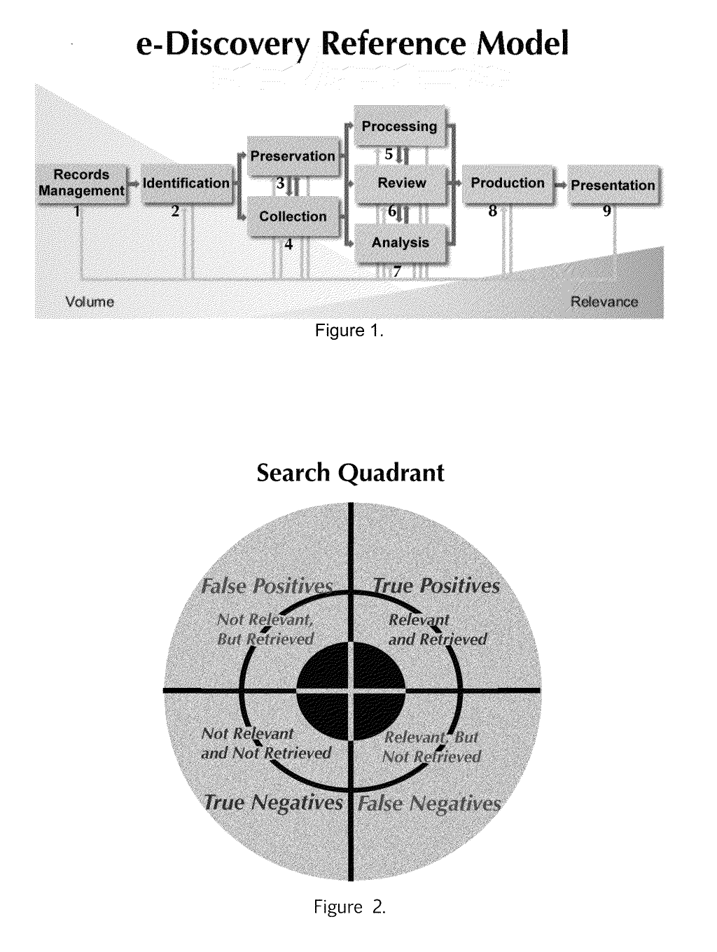

In the context of civil litigation, the invention processes are triggered by completion of the fourth step in the EDRM. FIG. 1. One embodiment of the invention provides computer-assisted systems for use in the fifth, sixth and seventh steps of the standard EDRM model (FIG. 1): Processing, Review, and Analysis.

Under one possible application, large datasets thought to contain ESI that might be responsive to an RFP are collected and delivered for processing, review, and analysis by the producing parties, typically by and through their attorneys, either in-house or outside counsel or other professionals or technology consultants (collectively herein “e-discovery attorneys”). Alternatively, the review can be conducted by an independent third-party retained by both the responding parties and requesting parties, typically with cost-sharing, but only the responding parties are provided with a copy of files initially categorized as privileged or confidential for final review, logging and production; all other files marked as relevant are produced by the third party reviewers to both sides. Such a third party arrangement is also indicated here by use of the term “e-discovery attorneys.”

One manner to demonstrate aspects of the invention under this application and assumed facts will now be described. The implementation described represents just one of many possible demonstrations and one of near-infinite different possible factual assumptions. Further, the order of the steps described herein are for demonstrative purposes only. The invention can be also presented in other steps, or some steps may be eliminated or combined. Further, the invention is not necessarily limited to the sequential order here described or assumed.

This demonstration of this one embodiment of the invented process begins by assuming that only email with attachments was been requested in the RFP. (Typically RFPs are not so limited, but this is chosen to simplify the demonstration, and the invention functions the same regardless of the degree of complexity of size of the collections presented.) It is further assumed that the email of 100 persons (hereinafter “custodians”) with custody of potentially relevant ESI has been collected from a server and delivered to the responding parties' e-discovery attorneys. Per standard procedures, the email with all attachments has been extracted and copied directly from the server and delivered in 100 separate PST files for the 100 custodians (assuming each custodian has only one PST) on any suitable media (hereinafter “Original Collection”). Further assume that the average size of the PST, or equivalent files, is 2 gigabytes (GB); thus, the total GB of the 100 PST files is 200 GBs.

The e-discovery attorneys will now employ one embodiment of the invented methodology to effectuate a quality-controlled, cost-effective review that transforms the Original Collection into a legally defensible final production of computer files in response to the RFP (“Final Production Set”). One embodiment of the Invention uses a series of processes to reorder and divide the Original Collection into two new collections: one projected to contain a legally defensible precision ratio of true positives to false positives, the Final Production Set; the other projected to contain a legally defensible precision ratio of true negatives to false negatives (hereinafter “Excluded Files”), as shown in the Search Quadrant, FIG. 2.

Upon receipt of the 200 GB of email with attachments, a rough estimate is made of the total cost to review the Original Collection without culling of any kind. This typically results in an extremely large time and cost estimate that lays a compelling legal predicate for the need to dramatically reduce volume of ESI to be reviewed by aggressive culling. This step can be skipped in certain circumstances, especially where there is already some degree of familiarity with the information and costs and the process can then begin with Step Two.

The Step One estimate begins by an approximation of the total amount of ESI stored in the 100 PST files. The total size of the files is easily known from the screen displays or other reports of any computer operating system. Here it is assumed that the files are exactly 200 GBs in size. But PST files are compressed and so the first step in the calculation is to estimate the total amount of ESI that is actually stored in the 100 PST files. In other words, how much ESI will there be for review after the PSTs are unpacked for review. The exact amount could be determined by actually unpacking each file, but this involves significant time and expense and is not necessary at this step of the process. So instead, an industry standard three to one ratio is used wherein it is assumed that the 200 GBs of compressed email and attachments will unpack to 600 GBs. This three to one ratio is a generally accepted value commonly in use by vendors in the e-discovery industry. It represents an average condensed value seen in multiple projects. The actual size can vary by as much as 25% or more depending on the actual contents of the email and especially the email attachments.

The industry standard convention is that 1 GB of electronic data will, in a business setting such as this involving a collection of emails and attachments, typically be comprised of 15,000 files with the equivalent of 75,000 pages of paper documents. Each email is considered a file and each attachment to an email is considered a separate additional file. These standard quantities are averages. In the page count equivalency the range can extend from a low of 50,000 pages per GB to a high of 100,000 pages per GB. Again, this depends on the type of ESI involved. Simple text files can comprise a large amount of equivalent pages, whereas graphic files a low amount. The same range applies to the assumption that 1 GB will consist of 15,000 separate files. When the PST files are actually unpacked and readied for review, you may find only 7,143 files on the low end with up to 33,333 files on the high end. The low end of 7,143 files is based on an average of 7 pages per file, the standard 15,000 is based on an average of 5 pages per file, and the high end is based on an average of 3 pages per file.

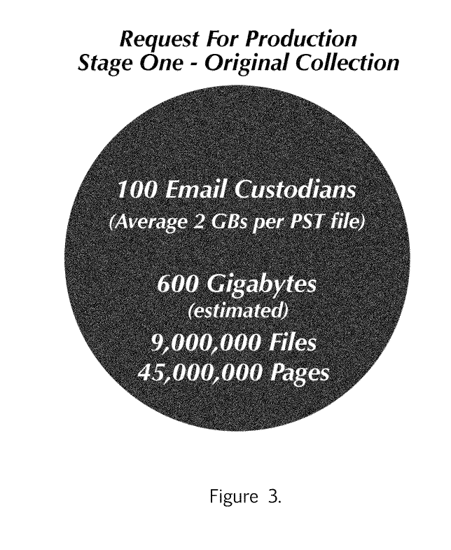

The total estimated volume of ESI potentially responsive to the RFP in the Original Collection is shown in FIG. 3.

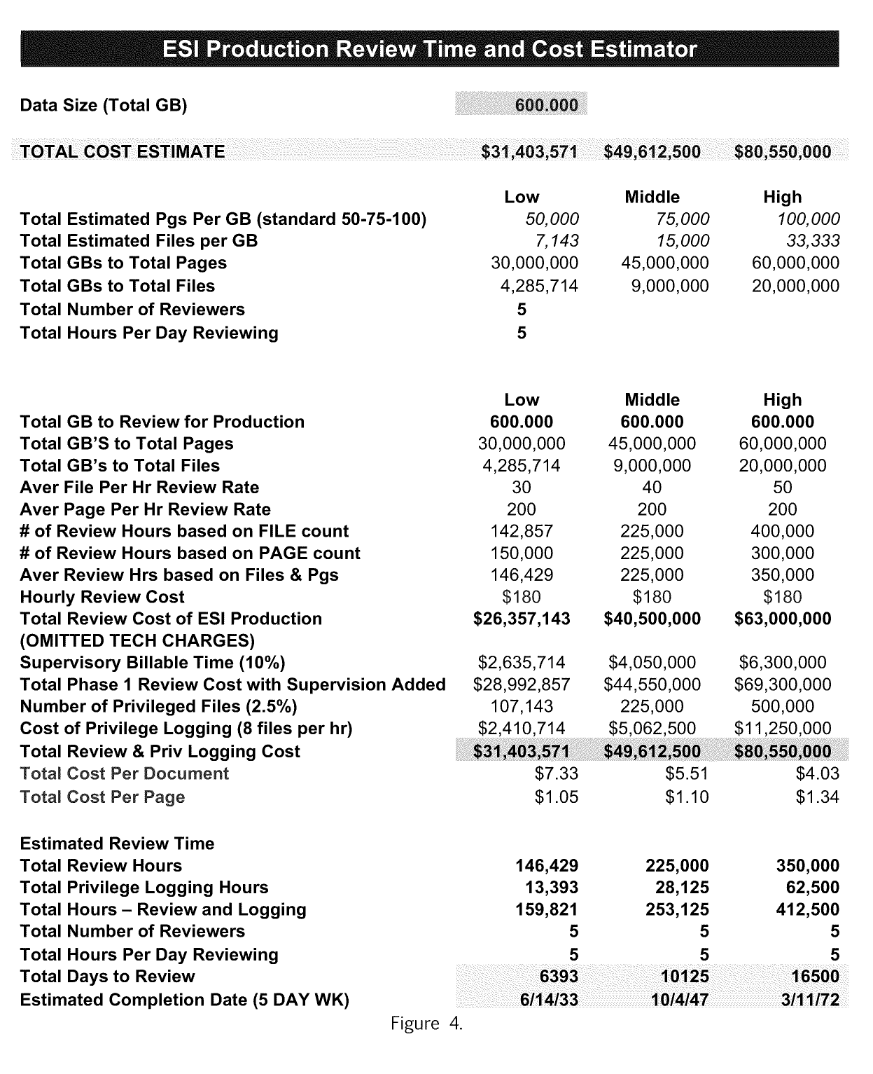

The next step in the estimate is to calculate a reasonable projection for the amount of time it will take to review this data. This can be done by many methods, only one of which is shown here using a combined page and file count method. The invention is not dependent on any particular type of estimation, and the one shown here is one of many possible aspects. For instance, the estimations could be done using page count alone, or file count alone, or weighted averages based on prior experience and historical values. Also, the estimate could build in estimated deduplications of exact or near duplicate files, where for instance it is known that ESI collections of one type typically have a certain percentage of duplicate files, and only one copy of the same, or nearly same, file will need to be reviewed. All methods use computer calculations, in this example, shown in FIGS. 4, 7, 9, and 12 below, Microsoft Excel, but any other spreadsheet program or software algorithm program would suffice. The example shown in these Figures uses an adaptation from a known spreadsheet format, but again, this is for illustrative purposes only. The invention is not dependent on any one form or organization of spreadsheet or number display, nor any one form or type of estimation.

The particular estimation method demonstrated here takes the total projected number of pages and files divided by known ranges of attorney rates of review for each. Then the average rate from the two methods (per page and per file) is calculated. There are three different assumptions for this method, labeled Low, Middle and High in the spreadsheet diagram below. FIG. 4. Again, the use of three assumptions is just one possible implementation and the form and type of estimate can vary without changing the invention methods and systems. The invention could just as easily use two scenarios, only one scenario, or four or more scenarios, or as mentioned, these steps could be entirely omitted. The Low scenario used here assumes that the collection will actually have an average of 50,000 pages per GB. The Middle scenario assumes that the collection will actually have an average of 75,000 pages per GB. The High scenario assumes that the collection will actually have an average of 100,000 pages per GB.

In all three scenarios it is assumed that e-discovery attorney reviewers will be able to review with computer assistance an average of 200 pages per hour. This starting assumed rate is based on experience with past projects involving business email collections. It is also assumed that a rate for number of files that can be reviewed by attorneys with computer assistance in an hour, but here the rate of review varies according to the three scenarios. Again based on past experience measured on number of records or files per hour basis, an average rate of 40 files per hour under the Middle scenario is assumed. Since the Middle scenario assumes an average of 5 pages per document, this results in the same equivalent review rate of 200 pages per hour. But based on experience, the files per hour rate can range from a low of 30 files per hour to a high of 50 files per hour. (There is often no direct equivalency of files per hour and pages per hour based on historical analysis of past projects as you might expect in theory. This is due to the enormous variety of actual files encountered, there content, and time needed to review and analyze different types of data.) These different rates of file review time are used in the three scenarios, which create different time estimates for the Low, Middle and High scenarios as shown in the below spreadsheet. FIG. 4.

The particular review rate values used here are not intended to in any way limit the invention, nor are the particular methods of estimation, be they either page count based, or file count based, or some other method. One embodiment of the invention utilizes cost estimations in an iterative fashion with search parameters.

In all estimate methods the first assumed values are usually averages based on different types of datasets. The historical averages by data type are constantly evolving rates, where faster rates are typically achieved. Enhanced technologies to date have allowed for ever-increasing rates of computer assisted human review. Examples include the use of software review tools such as Summation, and more advanced document clustering review tools. The first assumed numerical values for review rates of the Original Collection in Step One are not critical to the invented methodology because in later stages they are overridden by actual attained review rate values. In later stages of one embodiment of the invented methodology the projected estimates are made based on actual review times derived from measurements of attorney time incurred to review sample datasets.

An average hourly billing rate and number of lawyers is assumed. For example, in this example it is assumed that there is a billing rate of $180 per hour per attorney, and a team of five attorneys, each working an average of five hours per day on the review project. Again, all of these values can be changed to accord with the actual project circumstances with no impact on the one embodiment of invented methodology demonstrated here, just on the final estimated costs.

The estimated number of hours to do the review of the Original Collection under all three scenarios is calculated and then multiplied by $180 per hour. Thus under the assumption of 600 GBs, using the Low scenario where 50,000 pages per GB is assumed, the total pages is assumed to be 30,000,000. The Middle scenario of 75,000 pages per GB results in a projection of 45,000,000 pages. The High of 100,000 pages per GB results in 60,000,000 pages. At a rate of 200 pages per hour this requires 150,000 hours to review under the Low scenario, 225,000 hours to review under Middle, and 300,000 hours under the High. This is all shown in the spreadsheet below. FIG. 4.

Under the files per hour assumption it takes 142,857 hours for the Low, 225,000 hours for Middle, and 400,000 hours for High scenarios. The two estimates (file and hourly) are then totaled, and divided by two, here resulting in the following average values: 146,429 hours for Low, 225,000 hours for Middle, and 350,000 hours for High. Multiplying the hours, by $180 per hour, results in a projection of $26,357,143 for Low, $40,550,000 for Middle, and $63,000,000 for High.

The next step under this demonstration is to include attorney supervisory costs where the 10% value is typically used. Then additional time must also be added for privilege logging to complete the work in the Analysis step in the EDRM and thereby ready the ESI for production. See FIG. 1. This estimate again follows typical industry averages and assumes that 25% of files searched in the final review will be responsive, and that 10% of the responsive files will be privileged or contain privileged info. In other words, this calculation assumes a 2.5% document privilege rate. Finally, the logging cost estimate assumes a privilege logging rate of 8 files per hour, again at the rate of $180 per hour.

Adding these additional supervision and logging charges creates the grand total estimates for 600 GB Original Collection as follows: $31,403,571 for the Low scenario; $49,612,500 for the Middle; and $80,550,000 for the High. This is all shown in the spreadsheet below. FIG. 4.

The projected total times to complete the review and logging are 159,821 hours, 253,125 hours, and 412,500 hours. (The supervisory time is not added to the project duration, as this should be overlapping.) The total times are then divided by five attorneys working five hours a day to calculate the total number of days needed to complete the review: 6,393, 10,125 and 16,500 days respectively. Assuming this work started on Dec. 12, 2008 and five-day workweeks, the project would be completed under the three scenarios on Jun. 14, 1933, Oct. 4, 1947 or Mar. 11, 1972. The calculations are then performed by computer and displayed to the user, typically in a computer screen display, which can also be printed on paper.

One embodiment of the manner of output using a spreadsheet program, here Excel, is shown in the spreadsheet FIG. 4 of the Drawings, however, any suitable output or form of display and organization can be used.

The next step under this demonstration begins the iterative culling process to reduce the size of the Original Collection and begin creation of the Excluded Files set. The size of the Original Collection can be reduced or culled in a number of ways, none of which are inherent to the invention. This demonstration of the invented method will follow one of the more typical scenarios seen in e-discovery legal practice today, but the invention itself is independent of the particular culling techniques used and estimation values.

The responding parties at this point, if not before, should analyze the value of their case and determine a range of costs that they think would be reasonable to expend in a first round of discovery production. If possible, the requesting parties should be engaged and attempts made to reach agreement on: (1) the overall value of the case; and, related thereto, (2) the amount of money which would be reasonable for the responding parties to expend for the first wave of production. For this case let us assume the parties agree that there is $100,000,000 at issue. Let us further assume that the responding parties are willing to expend $1,000,000 for the first round of e-discovery, but the requesting parties disagree, and think that $2,000,000 is reasonable.

The parties agree that review of all of the emails and attachments of all 100 custodians, which has been shown to likely result in a cost of $50,000,000, is excessive and some reasonable culling of the Original Collection is required. The parties first agree to reduce the number of key custodians whose email will be reviewed from 100 custodians to 50, and they agree on which custodians to eliminate and which to keep. Alternatively, the responding parties make this decision on their own and risk later reasonability challenges on these decisions by the requesting parties. This reduction alone under the hypothetical reduces the size of the Original Collection in half, since it is presumed that the average per gigabyte per custodian remains the same and the total of the fifty PSTs is 100 GB, which expands out to 300 GBs after restoration.

This only reduces the total time and cost estimates by half, to approximately $25,000,000, and this is still far more than the $1-2 million dollar range that the parties think appropriate for this case. Therefore, as is typical for most e-discovery projects, much more aggressive culling is still required.

At this point the parties agree to further reduction by the use of keyword searches with Boolean logic. Again, many other approaches and culling techniques could be utilized, but the invented method would remain the same. Let us assume that the parties agree to a preliminary list of 100 keyword combinations.

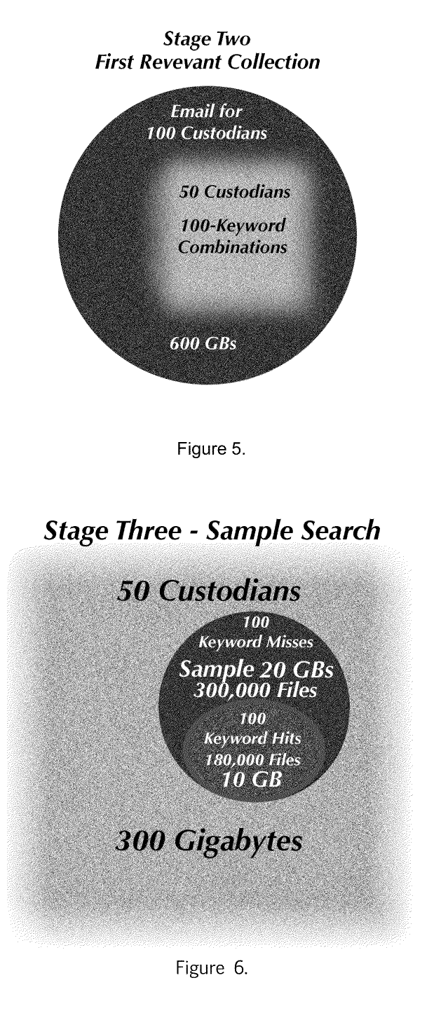

FIG. 5 shows this first reduction in size of the Original Collection by removal of the first set of Excluded Files. This first reduced dataset is hereinafter sometimes referred to as the “First Relevant Collection.”

The Original Collection set of 600 GBs of files has been reduced from 100 custodians to 50 custodians. This is estimated to reduce the total size of the First Relevant Collection to 300 GBs. Further, the files of the 50 remaining custodians will be reduced by 100 search terms. Only files containing one or more of the search terms will remain in the First Relevant Collection; all files of the remaining 50 custodians that do not contain at least one of the search terms will be added to the Excluded Files set. This Step Two reduction in total ESI from the Original Collection to the First Relevant Collection is shown in the drawing below. FIG. 5. The dark grey circle represents the Original Collection. The light grey box within the circle represents the First Relevant Collection.

The requesting parties would often at this point attempt to require a binding agreement by the responding parties as to keywords, and as mentioned, under current practice this would often be agreed to, based simply on purely theoretical speculation on the amount of ESI that might thereby be produced. Under the invention the responding parties would agree only to run a test search using a representative sample of the First Relevant Collection. Alternatively, the test search could be run on the entire file collection, not samples, but there is typically a high expense incurred related to opening all PSTs and running a search on such a large collection, and so this scenario is now usually avoided to conserve costs and time.

The parameters of the sample might then be negotiated by the parties; thus reducing the risk to the responding parties of later challenges to reasonability of these decisions Alternatively, the sample to be used to test the keywords could be unilaterally decided upon by the responding parties who own the data and thus are far more familiar with it than the requesting parties.

Here it is assumed that an agreement is reached on sampling. Next it is assumed in accord with common experience that three of the fifty custodians are considered by all parties to be the most important witnesses in the case. For that reason, a decision is made to search all of their email as part of the sample of the entire collection. Further, the parties agree that the requesting parties be allowed to select three more custodians, but only the email of these custodians from a certain date range which is considered especially critical to the case will be included in the sample search, say from between Jan. 1, 2006 to Dec. 31, 2006. Again, there is a desire to limit the size and number of the samples because of the mentioned costs associated with search based on size of the collection.

At this point, the PST files of the six custodians selected would be unpacked for search and review and the true size discovered. Let us assume that the three key witnesses had average size PST files that after unpacking resulted in emails and attachments having a total size of 6 GBs apiece, for a total of 18 GBs. Let us also assume they have a total of 270,000 files (emails and attachments). Next it is assumed that the three additional custodian PSTs also unpacked into 18 GBs, but that after date culling the total size is reduced to 2 GBs. Let us also assume they have a total of 30,000 files (emails and attachments).

The total data to be tested by search culling under the first sample would thus be 20 GBs contained in 300,000 files.

At this point a test run is made using the agreed upon 100 keyword combinations. The results of this test run can be stored in computer memory and displayed to the user on screen or printouts. This begins Step Three of this demonstration of one aspect of the invention.

Step Three under this demonstration is where the results of the keyword filtering performed in Step Two are studied. Again, the same method would apply if other types of filtering search techniques were performed in Step Two, such as a type of concept search. It is here assumed that the study shows that the 100 filtering terms and term combinations reduced the 20 GB sample by fifty percent (50%) to 10 GBs and reduced the number of files by forty percent (40%) from 300,000 files to 180,000 files.

This is shown in the FIG. 6 that shows the results of the 100-keyword combination search of the 20 GB sample set. The grey box represents all of the ESI held by the 50 custodians selected, which is estimated to be 300 GBs. The blue circle represents a 20 GB sample consisting of 300,000 files on which the 100-keyword search was run. The red circle within the blue circle represents the 180,000 files occupying 10 GBs of space that contained one or more of the keyword combinations.

The e-discovery attorney then evaluates the likely time and financial impact of applying the 100-search term filter by projecting the reduction achieved in the sample onto the entire First Relevant Collection. This gives a more accurate estimate of the actual size of the First Relevant Collection after applying the 100-search term filter. Thus the 300 GBs consisting of all 50-custodian files after expansion would likely be reduced by 50% to 150 GBs. In addition, the 4,500,000 files projected to be included in the 300 GBs using a standard value of 15,000 files per MB, would likely be reduced by 40% to 2,700,000 files. Thus the First Relevant Collection is projected to have 2,700,000 files taking up 150 GBs of space.

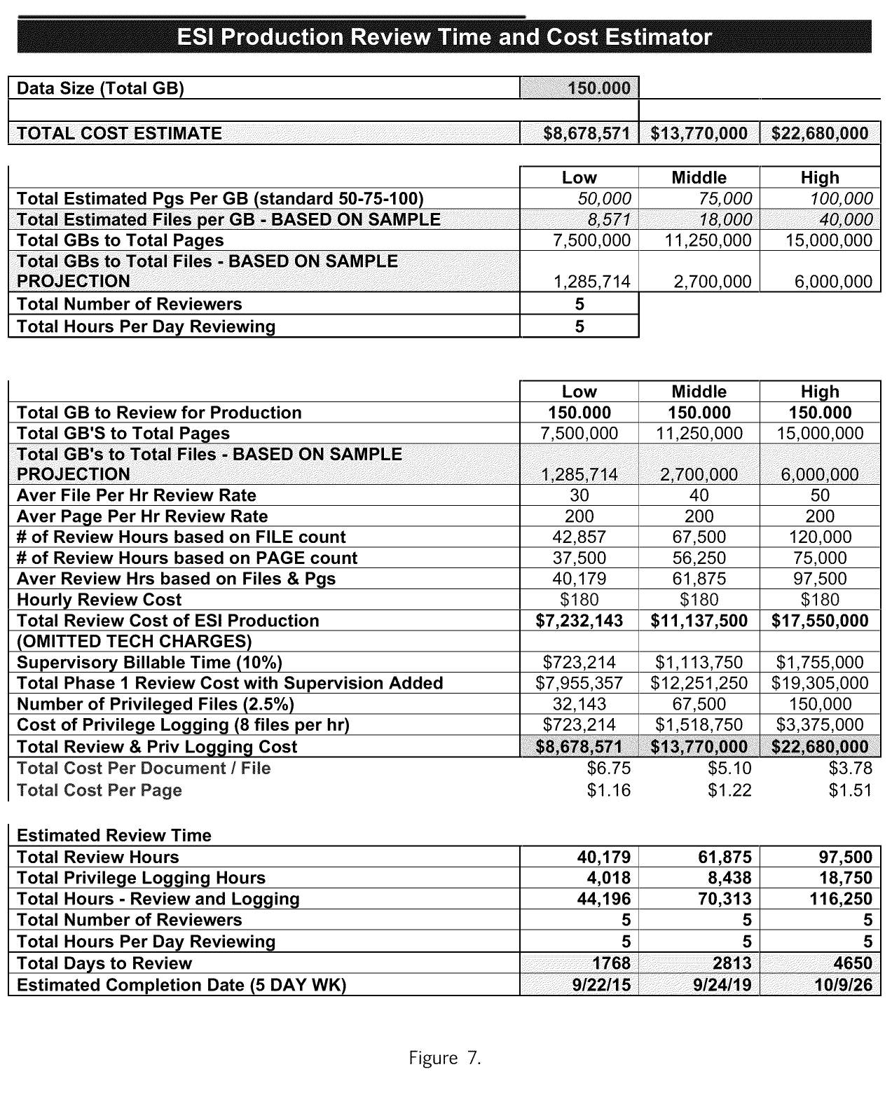

With this information from the first test sample the computer can calculate the likely size of the First Relevant Collection and estimate the total time and cost to review the pared down data set in the projected First Relevant Collection by using essentially the same calculations as before. The calculations are then performed by computer and displayed to the user, typically in a computer screen display, which can also be printed on paper. One embodiment of the manner of output using a spreadsheet program, here Excel, is shown in the spreadsheet FIG. 7 of the Drawings, however, any suitable output or form of display and organization can be used.

This second estimate will, however, be more accurate because it is based on a study of expanded PSTs and an actual file count discovered in the sample database, instead of projected standards. Thus under the standard values used in the First Step Original Collection it is assumed there would be 15,000 files in a GB. But in fact the study of the sample set found there were 18,000 files per GB, an increase of 20% over the expected value. (The 10 GBs of sampled data contained 180,000 files.) Thus the estimate in Step Three for the cost to review the First Relevant Collection uses different, more accurate file counts for the total estimated files per GB, namely 8,571-18,000-40,000 for the Low, Middle and High scenarios, instead of—7,143-15,000-33,333 in the Step Two estimation.

Thus the Step Three estimate projects a total file count in the First Relevant Collection of 150 GBs to be 2,700,000 files, instead of 2,250,000 expected under standard values not customized to fit this particular collection of emails and email attachments. Using the Low, Middle and High spread assumptions explained in the Step One estimate, there are estimates of page counts of 7,500,000 pages to 5,000,000 pages, and estimates of file counts of 1,285,714 files to 6,000,000 files.

In Step Three the same default review rates are used as before, and thus total times are estimated of 44,196, 70,313, or 116,250 hours, resulting in total costs of $8,678,571, $13,770,000, and $22,680,000 under the Low, Middle and High scenarios. Obviously, this projected cost to review the First Relevant Collection is still far too high based upon the parties expectations of reasonable expenditure for this case for first round discovery of between one and two million dollars. The spreadsheet detailing the computer calculations in the Step Three estimate is shown in FIG. 7. Again, this is just one embodiment of the manner of computer processing and output using a spreadsheet program, here Excel, and any suitable output or form of display and organization can be used.

In the fourth step of this demonstration the size of the Original Collection of files will be reduced again to create a smaller Second Relevant Collection and an enlarged set of Excluded Files. Since the parties now have a better idea of the impact of the previously negotiated culling factors of custodian count and keyword filters, it is now obvious that more aggressive culling is still required to reach the target range of $1,000,000-$2,000,000. In alternative scenarios, where the data in the collection is better known and there is more cooperation between the parties, the invention can commence with this Step Four and skip the first three stages. Again, there are many possible forms of application of the invented methods and this is just one example, of many, of how the various steps demonstrated here can be applied

The parties are now able to agree on a reduction of custodians from the 50 picked in the last step to only 15 in this step. This is a reduction of 70%. The parties assume this will result in a similar reduction in overall file size and count in the Second Relevant Collection. Thus they assume a total size reduction from 150 GBs to 45 GBs, and a total file count reduction from 2,700,00 files to 810,000 files.

A quick calculation shows that this is still not a sufficient reduction. A reduction by 70% of the prior bottom line numbers of $8,678,571, $13,770,000, $22,680,000 to $2,603,571, $4,131,000, $6,804,000 is still not sufficient to meet the parties' goals.

It is here assumed that the parties are unable to agree upon further custodian reductions to come within budget. It is further assumed that other limiting factors are not possible in this case for a variety of reasons, such as for instance, the application of date range restrictions, or further reduction of the number of custodians. Here it is assumed that the only method the parties can agree upon to further reduce the Second Relevant Collection is additional search culling. Thus they attempt to reduce the number of search terms utilized to reach relevant ESI, and also to tighten the connectivity of the terms used, so as to increase the cull ratio of the search.

They are able to agree to a reduction in the number of search terms from 100 to 75, and also to tighten some of the term connectors. Thus for example, one of the original 100-keyword combinations may have been “Atlanta” within 20 words of “green.” One or all of the parties may want to maintain these keywords but agree to lessen the connectivity count to 10 words. At this point, however, before there has been any keyword analysis, the Boolean logic is typically not subject to significant change. But in following stages, after there has been such analysis as called for by the invention, increased culling ratios are possible by adjustment to both the actual keywords used and the connectors. Similar logic applies to the use of concept search approaches.

In the Fourth Step the PST files of all 15 remaining custodians are unpacked and the revised 75-keyword search is run on this entire dataset. (At this point the additional costs associated with full collection searches is deemed acceptable and so searches of samples of the full remaining collection are no longer needed.) Further, at this point in a deduplication process for identifying and removing exact duplicate files would be employed. Variations of deduplication would be considered, including whether any near deduplication parameters will be employed, and in the case of email, whether the deduplication will be vertical only, which means applicable for one custodian only, or horizontal, which means all duplicates are removed across all custodian collections. Although the duplicates are not reviewed in the production subset, they are not placed in the withheld set; instead, information is typically maintained on the deduplicated files removed from review so that their original location and associations can be seen, or at least reconstructed upon demand.

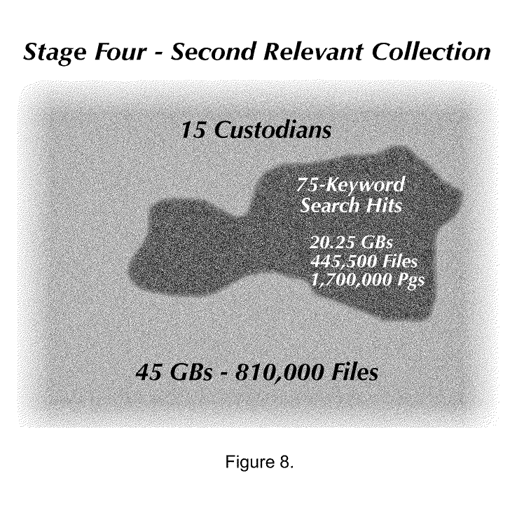

Let us assume that the revised keyword search and deduplication reduces the total GB size by 55% from 45 GBs to 20.25 GBs and reduces the total file count by 45% from 810,000 files to 445,500 files. The file count shows that the Second Relevant Collection has 22,000 files per GB, instead of the standard assumption of 15,000 files per GB used in the Original Collection and the value found in the Third Step from the sample of 18,000 files per GB. The Second Relevant Collection reduced by lowered custodian count and fewer, more refined search terms is shown in the drawing below. FIG. 8. The square grey area in the drawing represents all of the files of the fifteen custodians. The irregularly shaped dark grey area is the Second Relevant Collection. It represents all of the files within the collection of the fifteen custodians that contain one of more hits from the 75-keyword combination search.

At this point, it is assumed that the e-discovery attorneys have the software that allows them to determine for the first time what the actual page count is for the 445,500 files occupying 20.25 GBs of storage space. Assume they find a total of 1,700,000 pages in the Second Relevant Collection. Knowledge of the actual total page count allows for a more accurate estimation and obviates the necessity of the Low, Middle and High scenarios used in the prior estimates based on probable assumed page counts. If there is no ability to obtain a page count, these three scenarios could still be used for a range of estimates.

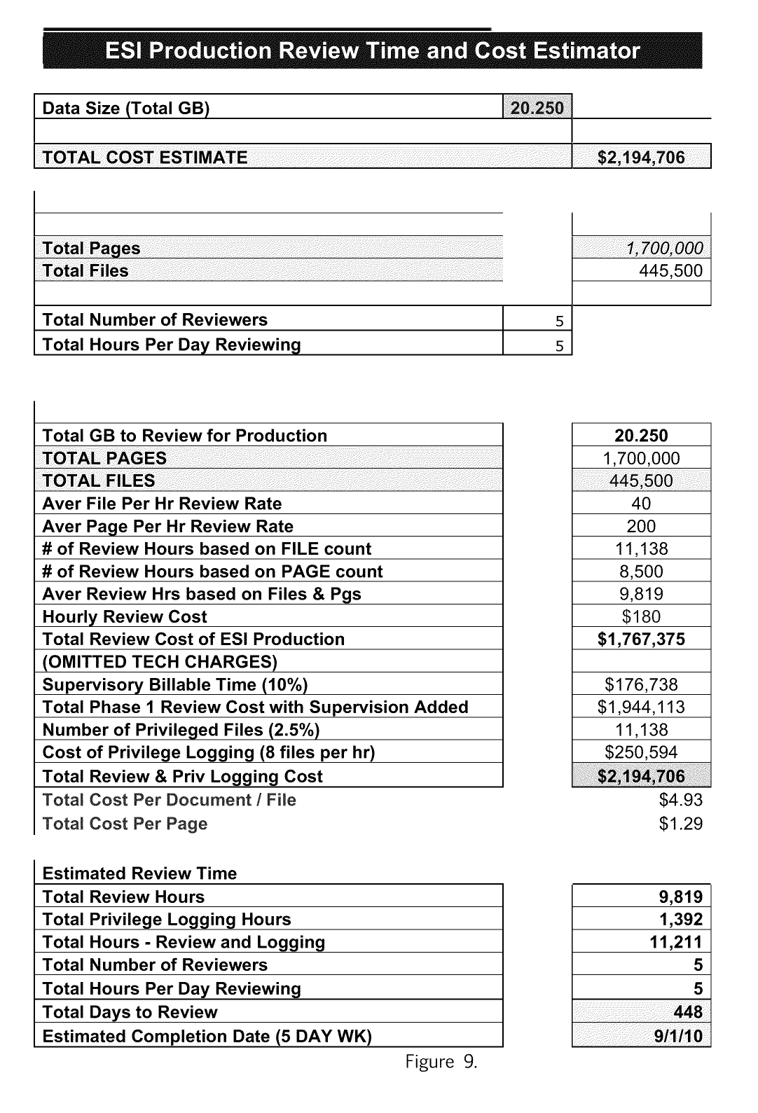

The computer calculations are then performed and displayed to the user, typically in a computer screen display, which can also be printed on paper. One embodiment of the manner of output using a spreadsheet program, here Excel, is shown in the spreadsheet FIG. 9 of the Drawings, however, any suitable output or form of display and organization can be used.

An estimate based on the reduced numbers of the Second Set as before shows a cost estimate of $2,194,706 and time of delivery estimate of 448 days. This is shown in the spreadsheet depicted in FIG. 9.

The above estimate shows the time and costs are still too high, but the e-discovery attorneys are nearing the budget goal. At this point in this demonstration of one embodiment of the invented method the actual review of sampled sets of files begins. Here the quality control process helps guide and justify the finer search-culling techniques. This involves a more careful study of the results of the search screening and actual e-discovery attorney review of the data.

This quality control step could be triggered earlier on the overall process depending on the circumstances and need to test proposed search parameters. For instance, there may have been an inability to agree to the reduction from 100 terms to 75 terms in this example assumed in the prior step. This might then trigger the necessity of deployment of the quality review process at an earlier step. For instance, the method could be run on the basis of a search of sample of an entire email database, just on a few select restores PST, or partials thereof, instead of an the entire remaining database under consideration as this example assumes. Alternatively, this process could be triggered later if there was a possibility and need for iteration of the prior stages three and four to reduce the overall ESI quantity.

The quality review step begins with an analysis of the search results and then continues with the selection and review of sampled data.

The individual search terms are first analyzed to evaluate their effectiveness. They are listed and ranked to show how many hits each search term combination produces. In this example all 75 terms would be listed and the number of hits identified by each would be noted.

This data would first be studied to look for patterns and anomalies. The actual files created by these anomalous extremes are then review by e-discovery attorneys.

For instance, one or more terms may produce far more hits than others. This could either mean that the terms are particularly effective at retrieval of responsive information, or particularly ineffective. At this point e-discovery attorney review of the contents of all of the files with matches, or samples thereof in the case of large collections, will quickly reveal which it is. In other words, the “precision” of the search term can be evaluated. In the later case, a more precise, accurate search, one with higher rates of true positives and lower rates of false positives, could be attained by modification, or in some circumstances, where there is a very low ratio of relevance found (low “precision” value), even elimination of these high hit-count terms.

Conversely, the terms producing only a few or no file hits are also studied. It is not uncommon to find that some terms created no hits at all. These terms are typically then eliminated from further consideration when the search has been run over the entire remaining dataset. The elimination of no-hit terms can be useful in improving the efficiency of future searches of different collections of computer files, such as in future RFPs where there is new data collected. It could also be useful if new custodians are added, or new sources of ESI are identified and collected for the current RFP. In alternative situations where a search is run on a sample set, the no-hit terms are also eliminated, assuming the parties believe that it is a fair and representative sample of the larger set.

Typically a few keywords will produce only a few hits. These are reviewed to evaluate “precision.” If a high “precision” ratio is found, consideration should be given to expanding these terms. For instance, the word connector distance could be increased to attempt to gather more files using those terms. Close alternatives to those words, or stemming of those words, or common misspellings of those words could also be employed.

Conversely, if there is a low precision ratio, they should, in most circumstances, be eliminated. The primary exception is a situation where the few relevant files found are weighted by the reviewers as being highly relevant or otherwise of special importance to the case. Thus even though the flat precision ratio may be low, this ratio should be subject to a third dimensional weighting factor if one or more highly relevant files are included in the relevant set. Then the terms should be revised accordingly, not eliminated. As a general rule the “precision” ratio should always be subject to weighting factors when a file of strong relevance or other special significance to the case is discovered.

In an alternate scenario, where only a sample dataset is examined, the search terms that produced only a few hits will also reviewed and evaluated for “precision.” Since these are small datasets, all files can be reviewed and reviewers can quickly, and thus inexpensively, determine the “precision” ratio. Imprecise terms, the one's creating few relevant to irrelevant files, can be eliminated as likely to produce little value to the overall search, again subject to the weighting factor if one or more of the few relevant files are judged to be of high importance.

In this demonstration of one embodiment of the invention, assume that 2 of the search terms are found to have produced no hits at all. They are eliminated, leaving 73 terms remaining for further analysis. Of course, under this scenario this elimination has no impact on the goal of reduction of the overall number of files to be reviewed before production. It could, however, have a slight impact under an alternate scenario where the search terms of a sampled set are analyzed. As mentioned, this can also be of importance where the content of the larger dataset to be reviewed changes, such as when new custodians are added or new data sources are added to the search collection.

Let us also assume that 7 search terms produce only a very few hits, say from 25 to 75 hits for each term. All of the files produced by these low-hit terms are reviewed by e-discovery attorneys and analyzed for relevance quality. Let us assume that they find that 3 of the search terms have no relevant information. These are then eliminated, reducing the keyword count to 70 terms. Let us also assume they find that 2 of the search terms have only a few relevant files, but are not ranked as being of high relevance or other special importance. The relevant files are segregated for future production, but these 2 search terms are eliminated from future consideration. (All files seen as relevant (true positives) are always so marked and segregated for production, regardless of whether the search terms producing them are later eliminated or modified.)

Finally, assume that the review of the files produced by the remaining 2 terms shows that one has a high “precision” ratio and the other has a low ratio, but includes a few highly relevant (strongly weighted) true positive documents. These search terms are then subject to further analysis and revision to attempt to expand the scope of their reach and thus improve both the “recall” of the project. For instance, assume the imprecise keyword that produced a few, but highly relevant results was “pig” within 2 words of “oink.” Analysis of the relevant files produced by this term suggests that additional relevant files would likely be produced by modifying the search term to “pig” within 10 words of “oink.” Assume also that a decision is made to revise in a similar manner the Boolean logic of the other keyword with a high precision ratio, but only a few overall hits.

Therefore, under this example the analysis of the 7 low-hit terms results in the elimination of five terms altogether, and the elimination of two more terms, but replacement by 2 new terms (in this case, ones with different Boolean logic). Thus there are now remaining 70 search terms, 2 of them new.

Now the one embodiment of the invented method is further illustrated with assumed findings by reviewers concerning the high-hit-count term results. Assume the study shows that 10 search terms produce a high number of hits, and that the 11^{th} and lower ranked terms are significantly less. The e-discovery attorneys in an exercise of judgmental sampling select the files produced by top 10 terms for actual review. At this point, further judgment must be exercised as to the time investment to be made in the review process of this judgmental sample. Let us assume that the top 10 terms have file-hit results as follows by ranking:

“Sanford”—45,000 files
“Truck”—28,000 files
“Motorcycle”—26,000 files
25,000 files
24,000 files
“Crown w/20 Cylinder”—23,000 files
22,000 files
21,000 files
“Chain”—20,000 files
- - -
19,000 files
11,000 files
10,000 files

Let us also assume, as is typical, that many of the terms will produce hits on the same files, and that after deduplication of files, the total files produced by all of the top 10 is 100,000 files, not the sum total of 253,000.

The attorney review begins by computer-assisted search of the keywords within files produced by the keyword sets. This is a kind of cursory review done on an informal random basis where an attorney randomly selects and reviews files produced a keyword. Assume that the first ranked keyword is “Sanford,” which was thought to be a distinctive word that would produce relevant files. Assume that a cursory, random attorney inspection of a small number of the 45,000 files produced by keyword 1, “Sanford,” shows that all of the files seen are irrelevant, that is, false positives. Instead, the reviewer notices that the word “Sanford” is contained in all of the emails from a particular person whose standard signature includes “Sanford” as part of their address. This computer-assisted attorney review has quickly shown that the original assumption as to uniqueness of the word “Sanford” was incorrect. It has proven to be a word, which often appears in a totally unexpected and irrelevant context and frequently produces false positives.

This initial impression of a low “precision” ratio gained by the judgmentally random review of a small number of the emails produced by the keyword “Sanford” out of the total of 45,000 is then further researched for confirmation. This could be done in a variety of ways, for instance by review of a valid statistically random sample of the 45,000 total. An error rate of 5% and confidence level of 95% is deemed acceptable in this example and thus based on standard calculations we here assume a review of only 1,537 samples need be undertaken for statistical validity. EDRM Search Guide, Appendix 2: Application of Sampling to E-Discovery Search result evaluation, Jan. 20, 2009, draft v. 1.14. Alternatively, in this example, the use of a “but not” type Boolean search of the 45,000 could be used to exclude the emails with Sanford as part of the address, or part of a set field, and the remaining set of documents is reviewed.

Assume this later alternative was followed here and that search cull eliminated 40,000 of the 45,000 total. A review of a random sample of the remaining 5,000 shows that the word “Sanford” is found within five words of the word “Trust” in almost all of the files within this set that are true positives, and further that these files are ranked and weighted as highly relevant. From this study a decision is made to eliminate the search term “Sanford” as imprecise and replace it with the search term “Sanford” within five words (“w/5”) of “Trust,” which is deemed to be sufficiently precise given the quantity and costs of review, especially weighting the value of the true positives.

Assume that the mentioned initial cursory search of the hits produced by the second ranked term, “Truck,” also shows all were false positives. Again, the parties had assumed this word would be used and found in relevant documents, and thus it was included in the 75 terms used in the test, but this assumption appears to be false. Further assume that a more detailed random review of the 28,000 files produced by term “Truck” continues to show all false positives. Again, assuming an error rate of 5% and confidence level of 95% is considered acceptable in this example, we again assume that a review of only 1,537 samples need be undertaken for statistical validity. Satisfied that this selection was an error, this term is eliminated.

Assume that the initial cursory search of the hits produced by the third ranked term, “Motorcycle,” also shows all to be false positives, that is, non-responsive or irrelevant to the RFP. The more detailed review of a statistical sample shows that the 26,000 files produced by this term do contain some relevant, files, but the reviewers notice that all of these true positives also contain another term known by them to be among the 75 keywords selected. Assume that is the ninth ranked word, “Chain.” Assume that further review confirms that the hits of relevance produced by “Motorcycle” are also contained as duplicative files produced by “Chain.” A review of a random sample of files found in the “Chain” set of files shows that a high “precision” rate. Based on this analysis the e-discovery attorneys decide to eliminate the term “Motorcycle,” and retain the term “Chain.”

Assume that review of a random sample of the 23,000 files produced by the sixth ranked term “Crown w/20 Cylinder” shows some relevant files, a few of which are judged to be of high relevance, but also a high number of irrelevant files, in other words, low “precision” ration. The reviewers further notice that the files of high relevance all have the terms “Crown” and “Cylinder” within 10 or less terms of each other. In this situation a further search of the 23,000-file subset is in order using a different proximity value. A search of the revised term “Crown w/10 Cylinder” is found to produce many more relevant files than the original, in other words, have better “recall,” such that the “precision” ratio is now deemed to be acceptable by the e-discovery attorneys. They therefore decide to replace this term.

Assume that review of sampled subsets of the files generated by the terms ranked 4, 5, 7, 8, and 10 show a reasonably high “precision” ratio in accord with the other accepted keywords. The e-discovery attorneys decide to retain these terms unaltered.

The net result of the search term analysis is that: (1) the highest ranked term “Sanford” has been eliminated and replaced by “Sanford w/5 Trust;” (2) the second highest ranked term “Truck” has been eliminated; (3) the third ranked term “motorcycle” has been eliminated; (4) the sixth ranked term “Crown w/20 Cylinder” has been eliminated and replaced by “Crown w/10 Cylinder.” This is a net reduction of two search terms and so the process has now reduced the total number of terms to 68.

The parties may be satisfied with the quality of the search terms, in the sense that they find the likely “precision” ratio to be acceptable, but still be dissatisfied as to the overall “recall” effectiveness of the terms under consideration. One or more may suspect, but typically the requesting parties, that the search is producing too many false negatives, and the “recall” is unsatisfactory. In other words, too many relevant electronic documents are not being located by the current search formulas and are instead mistakenly placed into the Excluded Files set. This can and should be addressed by a study of the files that were not retrieved by the tested search terms to try and gain some idea as to the ratio between false negatives to true negatives.

In this example, the 810,000 files examined in the collection have been reduced by the search parameters to 445,500 files where there is a match with one or more search terms. This means that 364,500 files have been excluded by the 445,500 hits. Thus in this demonstration of the invented method there has been a judgmental sampling study performed of the matched files, the “hits,” but none performed so far on the Excluded Files, the “misses.”

The 364,500 files excluded by the search terms can be searched by statistical random sampling. The size of the search is constrained both by random statistical significance factors and cost budgetary constraints applicable to the project. Again, assuming an error rate of 5% and confidence level of 95% is acceptable in this example, a review of only 1,537 random samples of excluded files was undertaken. The exact calculations on this sampling count stated here, and elsewhere in this demonstration, are not important to this aspect of the invention and are just used for illustrative purposes. Manual and computer assisted review of the random sample datasets of excluded files allows reviewers to determine whether any of the excluded files were actually relevant, and thus were false negatives. A ratio of true negatives to false negatives can then be calculated. A low ratio is to be expected. If the ratio is too high different search formulas and strategies should be considered. Study of any files excluded in error may also lead to ideas for additional or revised searches. Judgmental sampling of all, or segments of the Excluded Files can also be performed if the budget allows. For instance, searching the Excluded Files by custodians, other keywords, or certain date ranges.

The reviewers will also rank the relevancy of the false negatives to determine if any of the Excluded Files are considered to be of high relevance. If so, the nature of the false negatives will be studied and new strategies and keyword formulas developed to capture any similar relevant files in future search runs and thus reduce false negatives. This process increases the total number of relevant files retrieved from the total collection and thus improves both the “precision” and “recall” of the search.

This kind of testing of both included and excluded ESI, followed by redeployment of revised search screens, must sometimes be run in several iterative loops until an acceptable retrieval formula is developed. As previously noted, perfection in the form of total “recall,” or even total “precision,” is never possible and thus cost constraints predominate. In fact, when large amounts of unorganized ESI are involved, such as email with attachments as is typically found in business, research shows that searches of all kinds, including teams of manual review of every page, and advanced concept searches, less than one half of the desired files are found. George L. Paul and Jason R. Baron, Information Inflation: Can the Legal System Adapt?, 13 RICH. J. L. & TECH. 10 (2007); The Sedona Conference Best Practices Commentary on the Use of Search and Information Retrieval Methods in E-Discovery, 8 Sedona Conf. J. 189 (2007), available at www.thesedonaconference.org; Also See: Text Retrieval Conference 2008 by the National Institute of Standards and Technology a/k/a TREC 2008 Legal Track; Daniel P. Dabney, The Curse of Thamus: An Analysis of Full-Text Legal Document Retrieval, 78 LawLibr. J. 5 (1986). In other words, the “recall” ratio is 50% or less. In the first known study of e-discovery by attorneys using keyword search by Blair & Maron only 20% of the desired files were discovered. Blair, David C., & Maron, M. E.; An evaluation of retrieval effectiveness for a full-text document-retrieval system; Communications of the ACM Volume 28, Issue 3 (March 1985). (The Blair & Maron study measured retrieval effectiveness for 40,000 documents captured in a large corporate litigation, and found a large amount of indeterminacy of meaning in natural language in light of the fact that “while [the] lawyers and paralegals were convinced that they were retrieving over seventy-five percent of the desired documents, they were, in actuality retrieving only twenty percent!”). These tested methods did not employ the iterative, sampling techniques of this invention, but were instead one-time runs of a keyword search.

More advanced search technologies, including concept searches, are expected to improve upon the present poor (less than 50%) “recall” rate without use of the one embodiment of invented methodology demonstrated here. But regardless of the technology or search techniques employed, and how successful or unsuccessful they may be, various embodiments of invented methodology will improve the “precision” of the search and the reliability of the costs estimates. In theory, if the iterative sampling and testing methods here described in one embodiment of the invention were deployed a sufficient number of times (something approaching, but less than infinite, depending on the size and nature of the data collection), then total “precision” and “recall” would be attained, but in practice the cost and time involved make such perfection impractical.

The 445,500 files that were hits and were already examined by judgmental sampling as described above may also require additional study. Where appropriate, knowledge of the information retrieved before actual full review can be deepened by a statistically random sample of all hits. Again, assuming an error rate of 5% and confidence level of 95% is still acceptable in this example, a review of only 1,537 random samples of excluded files was undertaken. This further study may reveal the need for additional revisions to the search formulas; more terms may be deleted, revised or added.

Additional study of the 445,500 files remaining in the collection can also be made by other types of judgment sampling, in addition to ranked key words judgmental sampling previously described. For instance, custodian based sampling, or automated searches of subsets, or even searches of the original full set of 810,000 files, using other possible search terms that develop based on study of the actual information content.

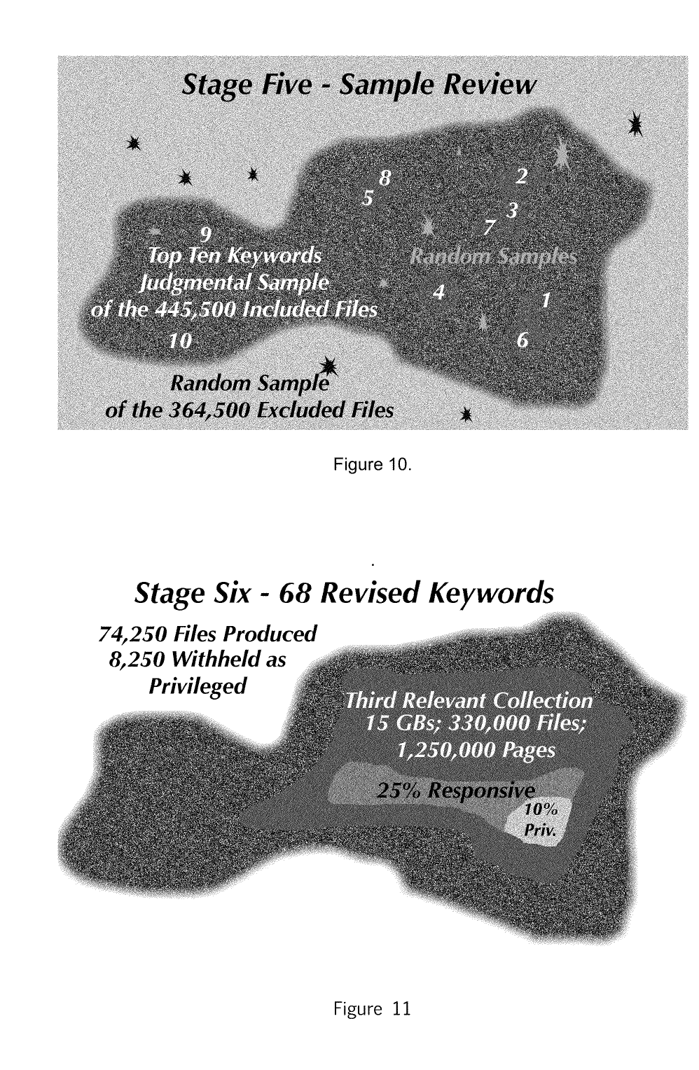

The drawing shown in FIG. 10 illustrates this Step Five review of both judgmental and random samples of the 445,500 files included by the 75-keyword combination and random samples of the 364,500 files excluded by the keywords. FIG. 10. The irregularly shaped dark grey figure represents the Second Relevant Collection. The light grey area surrounding and outside of the Second Relevant Collection represents the Excluded Files. The red shapes numbered 1-10 represent samples of the top-10 keywords, some of which have overlapping files. The light blue splatters represent random samples of the Second Relevant Collection. The black splatters represent random samples of the Excluded Files.

Next the speed or rate of review experienced for this collection of computer files is calculated. Here assume that the process of individual file review in this step databases as described above has taken a total of 100 billable hours. The reviewers have tracked the total number of files and pages they have reviewed and calculated hourly values based on the quantities reviewed. The results range between reviewers from 40 to 60 files per hours and from 190 to 210 pages per hour. A decision is made based on experience that the highest achieved rates, 60, and 210, are in accord with the rates that will likely be attained by all reviewers as an average in the full review process. This is because of the initial learning curve inherent in any review project. For this reason the e-discovery attorneys decide to use projected review rates of 210 pages per hour and 60 files per hour in the next price estimates.

The next sixth step in this particular demonstration of one embodiment of the invented methods is to rerun the search with the revised 68-keyword search terms and so create a Third Relevant Collection. It is expected that the new terms are improved by the initial 100 hour plus review study of the information generated in the last pass; that they are more focused than before, and thus will reduce the overall number of files and generate fewer false positives (improve “precision”). This assumption is tested in this step and the impact is quantified. The cost estimates are then made as before based on the revised page and file counts and revised review rates.

Assume that the new 68-term search criteria are again run of the same data collection as in the last search of 75 terms, in other words, all of the files of the fifteen custodians (the square light grey area in FIG. 8). Recall that the 75-term search reduced the dataset from 45 GBs to 20.25 GBs and reduced the total file count by 45% from 810,000 files to 445,500 files and the page count from an estimate of 3,375,000 to an actual count of 1,700,000. FIG. 8. Assume that the new 68-term set reduces the size of the total data collection from 45 GBs to 15 GBs, the file count from 810,000 to 330,000 files, and the page count from an estimate of 3,375,000 to an actual of 1,250,000. This is a reduction from the last pass of 20.25 GBs to 15 GBs, 445,500 files to 330,00 files, and 1,700,00 pages to 1,250,000 pages. This reduced set is herein called the Third Relevant Collection.

The drawing below shows the final culling using the revised 68-keyword combinations wherein the Third Relevant Collection is created comprised of 330,000 files, occupying 15 GBs of computer space, which if printed out would take up 1,250,000 pages. This is shown in FIG. 11. The dark grey shape represents the Second Relevant Collection. The irregular red shape within the Second Relevant Collection represents the Third Relevant Collection. The irregular blue shape within the Third Relevant Collection represents files that e-discovery attorneys determined were responsive to the RFP and were produced. The white shape within the blue represents files that e-discovery attorneys determined were responsive to the RFP, but were privileged, and thus were logged and not produced.

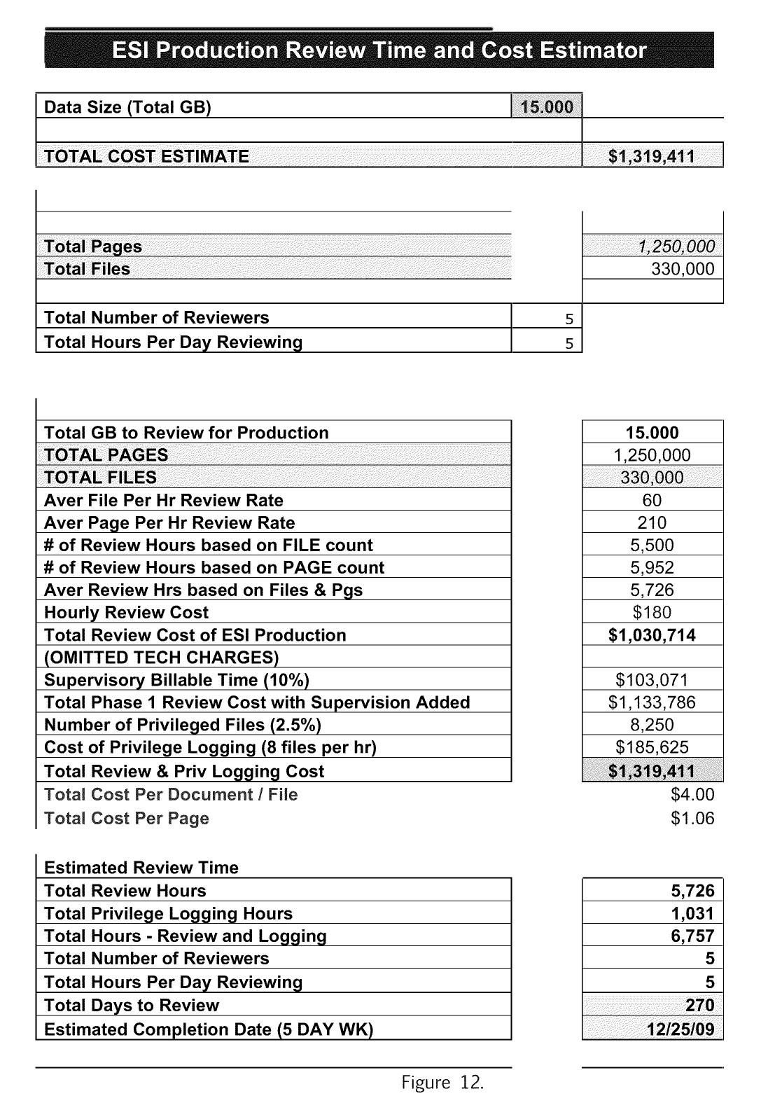

A new price estimate is then run using these new volumes and the new review rates found to be likely with the data under consideration in this case. The calculations are performed on computer and displayed to the user, typically in a computer screen display, which can also be printed on paper. One embodiment of the manner of output using a spreadsheet program, here Excel, is shown in the spreadsheet FIG. 12 of the Drawings, however, any suitable output or form of display and organization can be used.

The result is a cost estimate of $1,319,411 and total project time estimate of 270 days for the Third Relevant Collection. This is shown in the spreadsheet depicted in FIG. 12.

At this point, one or more of the parties may still be dissatisfied as to the quality or costs of the 68-term formula used and other parameters of the Third Relevant Collection. For instance, the responding parties may demand a lower price projection to review the Third Relevant Collection, since they generally bear the burden of payment of reasonable production costs. They may insist the estimated price of $1,319,411 is still unreasonably high under a Rule 26(b)(2)(C) proportionality analysis and must be lowered by additional culling. The requesting parties may also object. They may have expected a higher volume, or better “precision” or “recall,” or may have a general lack confidence in the current search parameters. For instance, they may have concerns that too many relevant files will not be located by the proposed search; in other words, that the “recall ratio” is too high and the retrieval formula will thus generate too many false positives that, if found, might help them to prove their case.

The parties at this point may agree to further judgmental and random sampling and testing as in the prior step. To address these concerns all or part of the Fifth Step processes would then be repeated one or more times and fourth and fifth relevant collections might be generated. There would be more study of samples of the results in an attempt to reduce the size of the retrieved collection to a more manageable size more within the budget of the responding parties, and/or to confirm the quality of the information which will likely be generated by the search method agreed to or proposed, that is increase the measured “precision” ratio and projected “recall” ratio. Alternatively, there could be new searches run to segregate data already in the collection into various sub-groups, such as potentially privileged or confidential, and improve the “precision” within these subgroups.

Let us assume here that no such additional review process is required. The parties have reached an agreement on how to proceed, or one or more have applied to the court for relief, including for instance, costs shifting past a certain expenditure level. With this assumption of agreement on the Third Relevant Collection, the estimation and culling processes demonstrated here end. The e-discovery process would then continue with e-discovery attorneys reviewing the Third Relevant Collection for final relevancy, confidentiality, privilege, and other determinations to create and make production of the Final Production Set.

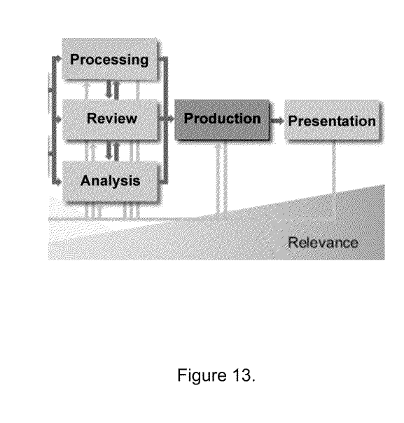

After final review, logging and production of the Final Production Set has been made as per the standard EDRM flow chart model shown in FIG. 13, the one embodiment of the invented method demonstrated here calls for study of the times and costs incurred in the final review before production.

The invented system requires that a careful record be kept of all review time while it is incurred (this is anyway the normal practice in the legal industry), and that the time records be correlated with the number of files and pages reviewed within that time. The actual review rates incurred in the project are then compared with the projected rates of review that were used in the final cost estimate. Any deviations will be noted and analyzed for possible adjustment of standard rates of review in future estimates, especially for any future discovery work in the same case of similar data stores. The actual costs incurred and time taken to complete the project will be measured and analyzed for the same purposes.

We here assume that time records of this project show that the five reviewers completed their review work in 5,000 hours, instead of the 5,726 hours expected. The projected rate of $180 per hour proved correct and thus the total costs incurred for the review was $900,000. On average the reviewers achieved a review rate of 66 files per hour and 250 pages per hour. The supervision cost more than projected, $162,500 instead of the $103,140 projected.

Assume the privilege log percentage value of 2.5% proved correct, that 25% of the files reviewed were relevant, and 10% of these files were privileged. Thus, 74,250 files were produced to the requesting parties in the Final Production Set and 8,250 files were withheld as privileged and logged. Also, assume that the privilege logging took exactly as long as expected, 1,031 hours, but cost slightly less than expected, $150,000 instead of $185,625. Thus the total actual cost of the review project was found to have been $1,212,500 instead of the $1,319,411 estimated.

Finally, the total projected project review time was 270 days. In fact, the project was completed in 250 days. It should have been competed in 241 days, since the total review and logging time was 6,031 hours, but there were additional unexpected delays, including illnesses. In view of the fact that the project was in any event ahead of schedule, the project manager elected not to compensate for the unscheduled delays by requiring longer workdays or work weeks by the reviewers.

Some time is also spent evaluating the quality of the search terms utilized. The actual “precision” of the search is measured by comparing the final tally of true positives and false positives. In this case, the final review indicated that there were three false positives for every one true positive; in other words, only 25% of the files reviewed (82,500 out of the total of 330,000 files) were found to be responsive. The responsive files making up were either produced (74,250) or logged as privileged (8,250). See FIG. 11. Comparisons are then made with the last “precision” predictions made. For instance, is the 25% rate within the range of expectations derived from the sampling. More detailed studies based on specific search terms or other techniques can be made at a later time before any additional searches on the same or related collections are performed.

If and when the responding parties receive additional RFP's for ESI in this case, they will be able to use the information on actual values gained in this Last Step to improve the accuracy of their next deployment of the Invention.

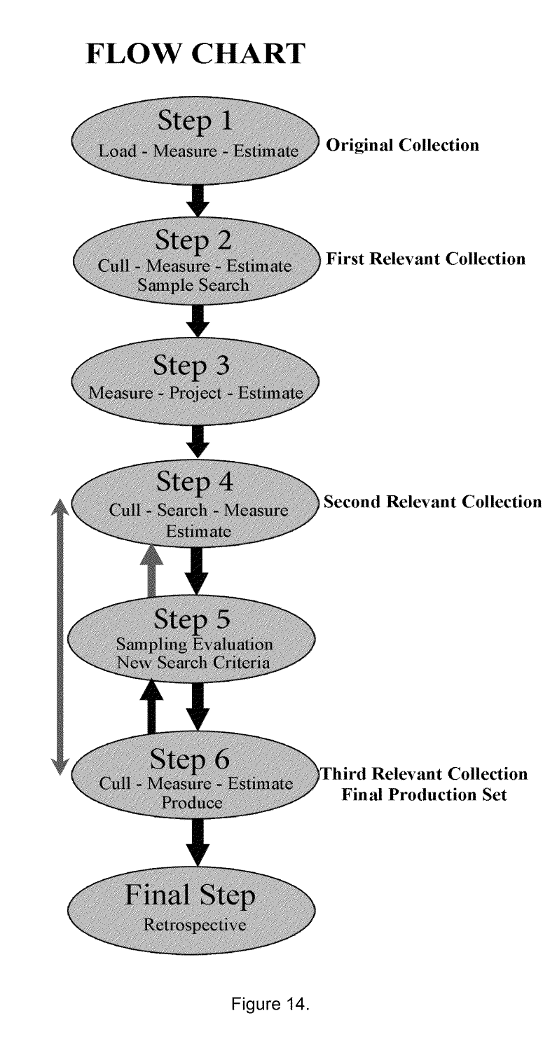

A Flow Chart of the overall system and method of one embodiment of the invention is depicted in FIG. 14. The chart demonstrates how the fourth, fifth and sixth steps may be repeated. Further, one or more of the preceding steps may be omitted in certain circumstances and, as mentioned, the invention should not be limited to the particular steps and order demonstrated here.

No artificial limits should be implied by the detailed description above because this is just an example of one possible application of the invention, and no limitations are intended.

For instance, although the above uses Boolean keyword filtration search techniques, the invention is equally applicable to all types of search and culling techniques, including, without limitation, more advanced concept search, category, and artificial intelligence techniques of all kinds. It should be understood by those skilled in the art that various changes, omissions, and additions may be made to the form and detail of the disclosed embodiment without departing from the spirit and scope of the invention, as recited in the invention claims.

Further, although the invention has been shown and described with respect to one method of page and file count review cost estimation, and one form of computerized spreadsheet calculations and display, the invention is equally applicable to all types of costs projection and estimation techniques, including, without limitation, estimates based on file count and file review rates alone, and all types of data calculation software and display. It should be understood by those skilled in the art that various changes, omissions, and additions may be made to the form and detail of the disclosed embodiment without departing from the spirit and scope of the invention, as recited in the invention claims.

Additionally, the present invention has been disclosed with respect to e-discovery and ESI related to legal issues in civil litigation, but one of skill in the art would recognize that the invention can be applied to other valuable ESI search and disclosure related circumstances outside of litigation, such alternative dispute resolution proceedings, or any other legal or quasi-legal proceedings for the resolution of civil disputes; a required or voluntary disclosure of computer files in criminal investigations or prosecutions; a required or voluntary disclosure of computer files in government investigations, including securities, environmental, and other regulatory compliance; due diligence investigations for business transactions, mergers, and acquisitions; an internal investigation, risk management, or research project of any kind; a freedom of information request or other government obligation to make disclosure; or, any other required or voluntary research or disclosure of computer files, including corporate security, corporate research, and other research and information analysis type issues, and is therefore limited only by the claims appended hereto.

The invention can be realized in hardware, software, or a combination of hardware and software. The invention can be realized in a centralized fashion in one computer system, or in a distributed fashion where different elements are spread across several interconnected computer systems. Any type of computer system or other apparatus adapted for carrying out the methods described herein is suitable. A typical combination of hardware and software can be a general-purpose computer system with a computer program that, when being loaded and executed, controls the computer system such that it carries out the methods described herein.

The invention can be embedded in a computer program product, such as magnetic tape, an optically readable disk, or other computer-readable medium for storing electronic data. The computer program product can comprise computer-readable code, defining a computer program, which when loaded in a computer or computer system causes the computer or computer system to carry out the different methods included in the invention. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

The preceding description of preferred embodiments of the invention have been presented for the purposes of illustration only. The description provided is not intended to limit the invention to the particular forms disclosed or described. Modifications and variations will be readily apparent from the preceding description. As a result, it is intended that the scope of the invention not be limited by the detailed description provided herein. On the contrary, this patent covers all systems, methods and apparatus coming within the scope of the appended claims under governing law.

What is claimed is:

1. A computer-based method for establishing, managing, and controlling the time, cost, and quality of information retrieval and production in electronic discovery, comprising:
dividing a collection of ESI into subsets using relevance search and sorting criteria in an iterative process to cull irrelevant, false positive ESI from the ESI collection into a final production subset that has an estimated total time and cost of production that falls within imposed budgetary constraints and/or precision and recall relevancy ratios;

2. The method of claim 1 wherein the total time and cost of production of ESI is estimated based on measurements of the number, size, and types of ESI in the original set, and each ensuing production subset, based on known or projected time and cost values;

3. The method of claim 1 wherein the precision and recall relevancy ratios of an ESI production subset are projected based on human review and evaluation of samples of ESI in the production and withheld subsets;

4. The method of claim 1 wherein adjustments are made to the relevance search and sorting criteria based on human review and evaluation of samples from the subsets of each cull run to project the precision and recall of the adjusted criteria and estimate the total time and costs for production of the then remaining production subset;

5. The method of claim 1 wherein the processes are repeated until a balance has been reached that is acceptable to the user or other outside authority, such as a judge, between the estimated total time and cost of production and the projected precision and recall of the production.

6. The method of claim 1 wherein an additional process is added after production wherein the actual incurred costs and time are compared with the projected costs and time, and the actual achieved precision ratio, and if known, the recall ratio of the final production are compared with the projected ratios;
determinations are then made as to adjustments that may appropriate in future estimates of the quality of the precision and recall and of the costs and time needed to fulfill new information requests that may be received concerning the same or similar sets of collections of ESI.

7. The method of claim 1 wherein after the initial relevancy culling(s) are run, an entirely new set of search criteria are implemented, which are designed to sort the then production set into various sub-sets of potentially relevant ESI, such as “relevant but privileged” and “relevant but confidential.”

8. The method of claim 7 wherein final human review and evaluation before production is limited to certain relevancy subsets of the production set and production is made of the balance of the production set without such review.

9. The method of claim 7 wherein final human review and evaluation is limited to “relevant but privileged” and/or “relevant but confidential” subsets of the production set and production is made of the balance of the production set without such review.

10. The method of claim 7 wherein the final human review and evaluation is limited to the “relevant but privileged”” subset of the production set and production is made of the balance of the production set without such review.

11. The method of claim 7 wherein there is no final human review of any files before production, but select subsets of the production set, such as “relevant but privileged” and “relevant but confidential,” are withheld from production per agreement or disclosure, and the balance of the files are produced without further review.

12. The method of claims 1 and 7 wherein there is no final human review of any files before production and the final production set is produced in full.

13. The method of claims 1 and 7 wherein there are no measurements or projections of recall ratios; instead, relevance is evaluated solely on the basis of precision.
